(19) United States
(12) Patent Application Publication
(10) Pub. No.: US 2004/0254873 A1
(43) Pub. Date: Dec. 16, 2004

(54) Method and system for generating interaction between an issuer of shares and its shareholders

(76) Inventor: Andrew John Loveland, Longstock (GB)

Correspondence Address: KILE GOEKJIAN REED & MCMANUS, 1200 NEW HAMPSHIRE AVE, NW, SUITE 570, WASHINGTON, DC, 20036, US

(21) Appl. No.: 10/831,168

(22) Filed: Apr. 26, 2004

Related U.S. Application Data
(60) Provisional application No. 60/465,198, filed on Apr. 24, 2003.

(51) Int. Cl. G06F 17/60

(52) U.S. Cl. 705/36

(57) ABSTRACT

Shareholders are often given various incentives/rewards by the corporation grateful for their loyalty. The disclosed system provides a valuable service by conveniently informing shareholders and others about the incentives to which the shareholders are entitled. The system comprises a database made up of compiled and collated incentives/rewards information gathered from a plurality of companies. The information is stored in a readily accessible database that makes this shareholder reward information widely available. The system incorporates commerce services that allow direct access to the shareholder rewards by the qualifying shareholders (online and offline) and convenient and automatic distribution of shareholder rewards through any payment system such as a credit/debit card payment systems. The system also includes a method by which an issuer can incentivize and reward its shareholders. Stockbrokers and other investment advisors can also use this system to find potential clients and to offer more comprehensive information about publicly traded companies from which their clients can make more informed investment decisions.

### RELATED APPLICATION DATA

This application claims the benefit of U.S. Provisional Application No. 60/465,198, filed Apr. 24, 2003.

### FIELD OF INVENTION

The present invention relates generally to providing interaction between a company that has issued shares and its shareholders. In particular the invention relates to collating and holding any information regarding shareholder incentives/rewards offered by a plurality of companies (online and offline), making this shareholder reward information widely available, incorporating commerce services that allow direct access to the shareholder rewards by the qualifying shareholders (online and offline) and the distribution of shareholder rewards through any payment system such as a credit/debit card payment systems whereby the system recognizes the cardholder as a shareholder in the parties of any given transaction and automatically credits the cardholder with the shareholder discount for which their shareholding qualifies. The invention also includes the distribution of dividends through such payment systems. Additionally the invention includes a preferable method by which an issuer can incentivize and reward its shareholders. Furthermore, the invention relates to a preferable method of determining the companies to be invested in by any investment product consisting of multiple companies such as a mutual fund for example.

### BACKGROUND OF THE INVENTION

The ideal investor for any company is a long-term shareholder, a loyal customer and a defender and advocate for their business. Of all, the best behavior an investor can exhibit is to hold on to the stock even if its performance falters.

Although an issuer may want to believe its shareholders will wait obediently through down cycles, restructurings, write-offs and underperformance, few shareholders actually will. Unless, of course, the company can strengthen their shareholder relationships and this is achieved by interaction with and the appreciation of their shareholders. Simply an open dialog with a shareholder could make the difference between the company's message being ignored or taken to heart.

Accordingly, companies offer incentives to their shareholders to court favor. From the Wrigley Company sending out free chewing gum holiday packages, to the Hilton Group offering stakeholders discount hotel rates and to British Airways enticing investors with lower airfares, many companies try to keep shareholders happy.

Tokens of appreciation such as valuable discounts go a long way towards building invaluable goodwill between the company and its shareholders, and can become good investments in a long-term relationship. They can also help score brownie points among those who may already like a company and would consider buying into it or expose them to new groups of potential shareholders by shedding some additional light on companies that aren't all too well known. However, if used to their full potential, shareholder rewards can enable greater interaction by encouraging an active interest in the company and allow proactive communication with the shareholder.

Currently companies are unable to truly capitalize on the potential of shareholder rewards to win friends, influence shareholders and encourage interaction between the issuer and investor.

One obstacle to marketing shareholder incentives and deepening interaction is the share registration structure; shares held in street-name prevent issuers from identifying many of their investors. To engage a shareholder in an incentive program an issuer would require a transfer of registration to the name of the individual shareholder. Assuming the issuer is prepared to budget for the costly promotion methods available and is successful in getting its message to the street name shareholder, the issuer is still faced with the fact that few shareholders will want to register their shares directly as it will require them to sacrifice the services of their brokerage.

This introduces a further obstacle; the prohibitive cost of promoting a program. To promote the program effectively an issuer would have to campaign all retail investors. This is in part due to street name holdings blocking information on existing investors but also because a successful shareholder loyalty program will target prospective new shareholders as well.

An existing compromise for an issuer is to promote its shareholder incentives within their website. Typically this is within a section allocated to ‘investor relations’. However this method of promotion is flawed not just because it is dependent upon retail investors having an unrelated reason to visit the site. The draw of an investor relations area of a website is information relating to the companies performance, financial statements, annual meetings and the like. Indeed information provided by financial organizations that service shareholders that also provide further impartial commentary and value added services. In effect, negating the need for a shareholder or potential new investor to investigate an issuer's investor relations web pages.

Furthermore an issuer has the added difficulty of how to make the actual shareholder incentives readily available and easily accessible. Their effectiveness as a program will be limited by restrictions on where the incentives can be enjoyed and the ease by which they can be redeemed.

Unless an issuer simply settles for providing their discounts by way of coupons sent only to their registered shareholders, the company requires a commerce system that recognizes a shareholder and its eligibility for a reward. The cost of providing specific functionality just for the issuer's shareholders invariably proves prohibitive, particularly in light of the promotional difficulties and uncertainties. Equally, there are both additional cost and operational difficulties implied in making such functionality accessible other than only through their investor relations web pages or through their customer loyalty card.

An issuer will be offering rewards to shareholders they do and do not know. Due to current processes available they are unable to effectively promote these programs to the unknown shareholders and to a lesser extent known shareholders. They are unable to provide easy and readily available access to their shareholder incentives and consequently many of these shareholders will not know that they are eligible for shareholder privileges—despite the fact that they maybe a frequent purchaser of the issuers products and or services.

Therefore there remains a need for issuers, as a whole, to gain a greater understanding of who their shareholders are; a need for greater interaction between an issuer and its shareholders; a need for a vehicle by which an issuer can ensure its shareholders and prospective shareholders learn of its shareholder rewards; a need for a vehicle by which issuers can ensure their shareholders benefit from the rewards they are eligible for.

Aside from the needs of the issuer, the shareholder also wants to receive these perks on offer for their continued support. Investors will choose to purchase stocks in a company often on the basis of what dividend is payable in addition to the opportunity for capital growth.

In the same way, an attractive shareholder rewards can affect an investment decision made by a retail investor. Accordingly investors have a need for the information regarding the shareholder rewards, whether they relate to an issuer whose equity they hold or that they may consider purchasing. Furthermore, given these investment decisions are often made under time constraints, an investor does not want the untimely task of having to call each issuer nor visit each issuers investor relations to find out what incentives are currently being offered.

In addition, important as dividends and rewards maybe they will only be of value to an investor if they are worth more than the time and effort involved in collecting them. In the case of dividends, an issuer's registrar will arrange for all dividends to be paid directly or, in the case of shares held in street name, with the help of the representative brokerage. Therefore the time and effort expended on the part of the shareholder is minimized. The same is not true of shareholder incentives. The shareholder incentives are not generally available, particularly to those with street name holdings, and are subject to restrictions in how easily they can be accessed.

Accordingly there is a need for a source that maintains all current information relating to all shareholder incentives offered by publicly quoted companies and for this information to be accessible to the retail investors of a plurality of organizations seeking to provide investor services to individuals. There is also the need to provide shareholders with easier access to the shareholder privileges for which they are eligible and this includes the effortless distribution of shareholder rewards through any payment system.

Furthermore, through the process the invention also proposes the distribution of dividends through payments systems such as debit and credit cards. As while the process of providing shareholders with dividends involves minimal effort on the behalf of the shareholders, this is not true of the organization distributing the reward. The issuer or its registrar will physically send checks to its registered shareholders and those registered parties who manage nominee accounts on behalf of investors are also then required to distribute these funds.

It has been noted above that investors will make decisions based upon the opportunity for capital gain as well as the dividend yield of an investment. They may also choose to invest in companies that offer shareholder incentives as a way of increasing the effective yield they receive from owning the shares. However, investors are not currently able to invest in products that give an indirect equity holding in a company (such as mutual funds and equivalents thereof) that also offer shareholder rewards. I.e., there are no such investment products that cater for those who wish to earn capital growth, dividends and shareholder rewards. Accordingly the invention proposes mutual funds, and equivalent investment products, that are composed exclusively of companies that offer shareholder rewards. And, furthermore, as explained hereinafter a method of ensuring indirect investments in organizations can be recognized as being eligible for shareholder incentives.

### SUMMARY OF THE INVENTION

Briefly described, the present invention comprises a method of increasing interaction between an issuer and its shareholder, based largely upon the promotion of, and accessibility to, an issuer's shareholder incentive programs. In accordance with the present invention forms of shareholder incentive programs are made much more powerful.

The invention is directed at collating, from all issuers of stock, information regarding shareholder privileges offered by each issuer. Consequently, the invention is directed at holding said information in a central data-warehouse and making this information widely available to shareholders and potential new shareholders alike.

In the mechanics of the present invention, the central data-warehouse maintains current records of shareholder rewards through regular, systematic updating ensuring that all information reflects the offerings available at a given moment. This, inter alia, allows the issuer to be flexible with the reward that they wish to offer, changing for example the reward form or focus according to market trends or perhaps a company's inventory. In addition, functionality enabling the ‘slicing and dicing’ of the database-held information is incorporated so as to allow the flexible retrieval of information using multiple search criteria.

The present invention includes making the information available to those organizations that serve investors as well as the investors directly. Accordingly the invention includes presenting the database through a proprietary source such as a shareholder rewards website and through its seamless incorporation into the existing data provision infrastructure maintained by other organizations.

In one embodiment, a retail investor wishing to research a prospective investment uses their preferred information source (e.g. an online brokerage such as E*Trade, TD Waterhouse or information provider such as MSN Money, Yahoo! Finance etc.). Upon requesting company related information, the user will be presented with all relevant shareholder privilege information in addition to the expected news, stock price, ratings, and dividend yields etc.

Further, shareholder reward information may affect a shareholders intention to purchase an issuers wares in the same way it may affect an investors decision to purchase an issuers stock. Accordingly, under the present invention, the information is made available through organizations that provide services to consumers such as credit card issuers and online shopping portals (e.g. Yahoo! MSN Shopping etc.)

As will be described, the mechanics of the present invention also include automatically alerting shareholders to rewards on offer by a respective issuer. This will occur through both online and offline mediums of communication such as automated electronic mail alerts or traditional postal mailings.

As implied by the automated electronic mailings, the present invention includes the collating of information relating to the shareholders themselves. This information will include, without being limited to, information on the shares held by the investor and contact information that will provide for further communication.

The present invention is also directed at providing commerce functionality linked to the aforementioned central-data warehouse. Consequently, the present invention is directed at providing shareholders with ready, and easy, access to the shareholder rewards and not only information about them.

In the mechanics of the present invention, online and offline commerce functionality is linked to the central data warehouse. Where the present invention includes information regarding an issuer's shareholder rewards it will also incorporate functionality that enables shareholders to perform the necessary actions that merit their shareholder rewards. Where shareholder rewards are provided in return for a transaction such as the purchase of the issuer's wares for example, the central data warehouse will facilitate the selling of the issuer's wares. As implied by its link with the central data warehouse, the present invention provides this functionality to all aforementioned organizations incorporating the central shareholder resource into their own services (i.e. online brokerages, banks, information providers, shopping portals) as well as a proprietary shareholder rewards web site. In addition, the mechanics of the present invention include functionality that enables the central data warehouse to automatically recognize an investor's shareholdings and thereby their eligibility for prospective shareholder rewards.

To expand, in one embodiment, an online brokerage provides its retail investor clients with access to shareholder privilege information as part of its information provision services. A client of the brokerage is looking to purchase a computer and he owns Hewlett Packard shares. In accordance with the invention the client is able to see from the brokerage provided snapshot of ‘HPQ’ that a 5% discount is offered to shareholders and consequently he opts to purchase a Hewlett Packard PC. In accordance with the invention, the client is presented with a number of publicly quoted companies through which the PC can be purchased who also offer shareholder rewards. One department store, Macy's, offers a shareholder discount of 12.5% on the first $7,500 spent in a given financial year. However, eligibility requires a shareholding of 200 shares and the client owns none. In light of the fact the investors PC costs $2,000 the additional $250 shareholder discount available encourages the investor to purchase the required 200 share stake in Macy's. The client is now eligible for a 17.5% discount, equating to a $350 reward. As will be shown, in accordance with the invention the investor is recognized as a shareholder in both HPQ and Macy's and is provided with a direct link to an online Macy's purchasing service in order to complete the PC purchase.

Furthermore, the present invention is directed at providing shareholders with automatic access to shareholder rewards through any consumer payment system, such as the debit and credit card transaction systems of Visa, MasterCard, American Express and Discover. Consequently, the present invention is directed at: enabling any payment system to automatically recognize whether a cardholder is a shareholder in the parties of a given transaction; at automatically determining whether the issuer's products purchased or the merchant from whom the purchases are made are eligible for a shareholder reward; at automatically crediting the cardholder with their shareholder rewards regardless of whether they are aware that rewards are being offered.

Additionally, the present invention incorporates flexibility in the way issuers can finance cash equivalent shareholder rewards and in the way shareholders can receive their rewards. In one embodiment, shareholders receive cash equivalent shareholder rewards such as discounts and rebates through their payment card transactions. The administrative body overseeing the distribution of rewards collects together the rewards payable by each issuer over a given period of time. As payment for the shareholder rewards from the issuers, the administrative body accepts, inter alia, cash, marketable securities, treasury stock and newly issued stock.

Thereby, in distributing the rewards the administrative body can in turn offer the shareholder payment of their rewards in the form tendered by the issuer where not cash. The administrative body will always provide the shareholder with the option of cash as the alternative forms of payment accepted, such as the aforementioned treasury and newly issued stock, will be immediately tradable. In the case of the issuer financing the cash equivalent rebates with treasury or newly issued stock, the shareholder has the opportunity to reinvest their reward into the stock of the issuer in much the same way as a ‘Dividend Reinvestment Plan’ (DRIP).

Furthermore, in accordance with the mechanics of present invention, cash equivalent shareholder rewards such as discounts or cash rebates can be provided in the form of preferable credit terms. To explain, again with the embodiment of a credit card payment system; a shareholder purchases a product with its credit card. The shareholder reward applicable to the purchase is a 3% discount. The terms of the credit card are that the cardholder has 30 days interest free credit from the time of the transaction, after this 30 days there is a requirement for the cardholder to pay a minimum proportion of the balance and the remaining balance is then subject to an interest charge of 12% or 1% per month. According to the present invention, the shareholder can use its 3% discount to offset the 1% interest charge of the second, third and fourth months. Thereby the net effect of the reward is to provide the shareholder with 4 months interest free credit and not one. It is feasible that four months interest free credit would be more appreciable as a reward than paying 97% after 30 days.

In accordance with the foregoing, shareholders are able to leverage their interest in the issuer and the discount they are eligible for to gain low cost credit. This is a continuation in part of patent application U.S. Ser. No. 09/881,619 to Loveland, Andrew that proposes the leveraging of portfolio held investments in order to receive low cost credit.

It is noteworthy that rewarding consumer purchases with newly issued stock is subject to current patent applications, U.S. Ser. No. 09/881,619 to Loveland, Andrew and U.S. Ser. No. 09/938,950 to Glover, Eiland; et al. Unlike the use of treasury stock or stock acquired from the market, as also covered by both patent applications and additionally patent application U.S. Ser. No. 10/226,899 to Palcic, Patric M.; et al, the issuer is provided with financial benefits stemming from the fact that payment is not taken from their cash reserves and thereby does not impact there cash flow. It also reduces the need for debt to finance operations, thereby alleviating the interest drag on the company and improving the credit position of the company by decreasing its debt to equity ratio. However the flaw of rewarding consumers with issued stock is the dilution of ownership; rewarding consumers generally with newly issued stock results in an increase in shares in circulation and an increase in the number of investors owning the stock. Accordingly, an issuer will have to have its shareholders support the dilution of their ownership.

Unlike the foregoing applications, the mechanics of the present invention see to the rewarding of shareholders with newly issued shares and not consumers as a whole. In so doing, while the shares in circulation still increase the number of shareholders does not and with the general acceptance/success of a shareholder reward program the proportional ownership of each shareholder is may to remain similar. Thereby this form of ‘equity reward’ lessens concerns of shareholder ownership dilution.

### BRIEF DESCRIPTION OF THE DRAWINGS

The advantages and aspects of the present invention will be more fully understood in conjunction with the detailed description which follows, and the accompanying drawings, wherein;

FIG. 1 is a block diagram illustrating the main functional components of a preferred embodiment of the invention.

FIG. 2 is a block diagram showing greater detail of exemplary computer systems employed to implement a preferred embodiment of the invention.

FIG. 3 is a flow chart illustrating the data exchange between the parties relevant to the invention.

FIG. 4 is a flow chart illustrating the clearing as settlement of shareholder rewards according to the invention using VisaNet as an example payment system.

FIG. 5 is a flow chart illustrating the authorization of shareholder reward eligibility incorporated into the clearing and settlement process.

FIG. 6 is a flow chart illustrating an alternative method of settling shareholder rewards where the cardholder is a client of a partnering broker dealer.

FIG. 7 is a flow chart illustrating the interaction between a partner broker dealer and the Database Administrator.

FIG. 8 is a flow chart illustrating the general interaction between a partner share issuer and the Database Administrator.

### DETAILED DESCRIPTION OF THE INVENTION

During the course of this description, like reference numbers will be used to identify like elements according to the different views that illustrate the invention.

As used herein, the term “Company” refers to an entity implementing the invention and therefore, providing the services. As used herein, the term “Card” or “Cards” refers to payment cards collectively including debit and credit cards. As used herein, the term “Cardholder” or “Cardholders” refers to those to whom Cards have been issued by the Card Issuers. As used herein, the term “Card Issuer” or “Card Issuers” refers to those organizations that issue payment cards to customers. As used herein, the term “Database Administrator” (“DBA”) refers to an entity managing the database implied by the implementation of the invention. As used herein, the term “Issuer” of “Issuers” refers to those companies that have issued shares to shareholders. As used herein, the term “Merchant” or “Merchants” refers to those entities that provide goods and services for sale. As used herein, the term “Payment System” or “Payment Systems” refers to organizations such as Visa, MasterCard, American Express and Discover that are responsible for the authorization, clearing and settlement of transactions made using a Card. As used herein the term “Product” or “Products” refers to goods and services available for purchase. As used herein, the term “Registered Shareholders” refers to those shareholders who have registered their shareholding in their own name with an Issuer or an Issuer's registrar. As used herein, the term “Street Name” refers to the registration of securities held in the name of the owner's broker.

Before describing the Figures in detail, an overview of the process follows to aid in the understanding of the invention.

The invention facilitates widespread, effortless and real time access to, and acceptance of, incentives offered by the issuer of shares to its shareholders. In so doing the invention generates real time interaction between the issuer, its shareholders and prospective new shareholders.

The invention ensures all information regarding the shareholder rewards offered by share issuers is made available to all shareholders and prospective shareholders. Furthermore, the invention enables the rewards for which a shareholder is eligible to be automatically available through any payment system such as debit and credit cards that they may use. Advantageously, the invention makes shareholder incentives available to both registered and street name shareholders that would otherwise remain unknown to the Issuer. Consequently the invention provides a uniquely complete database of an Issuer's shareholders whether registered or not and provides the information that can allow communication between an Issuer and its shareholders.

The mechanics of the invention makes the scheme attractive to Issuers, financial services organizations such as broker dealers, Payment Systems, Card Issuers and shareholders.

Issuers are attracted to the scheme as the process provides a value proposition that results in greater transparency of its investor base and an unprecedented interaction system with its shareholders. The process enables the Issuer to incentivize the holding of shares across its entire shareholder base while also encouraging the education of both existing and prospective shareholders in the operations of the Issuer. In essence an issuer can successfully develop widespread shareholder loyalty.

In so doing, the mechanics of the invention also provides the issuer with a most effective rebate system, plausibly at no incremental cost, that not only offers uniquely efficient promotion and fulfillment of rebate schemes but also unique flexibility due to real time interaction, allowing an issuer to adjust schemes as and when according to market or trading conditions. The mechanics of the invention also support and fulfill on their behalf the innovative shareholder reward scheme (highlighted in the foregoing Summary) that enables a customer to convert a discount offered on a Product purchase into a period of preferential interest terms on their credit card.

As previously stated the invention also advantageously provides the issuer with the identity of its street name shareholders. While for the first time this enables the Issuer to have interaction with its complete shareholder base it also provides an opportunity for the issuer to reduce its share Registrar costs. An Issuer currently encourages the registration of shareholders so that the issuer can identify its shareholders and interact with them. Marginal cost would include printing and distribution costs associated with company documents and reports. This is in contrast to shareholders using a brokerage as a nominee. The Issuer need only provide the brokerage with information and the brokerage is then obligated to distribute all such information to their shareholders. Accordingly, as the invention can make Street Name shareholders accessible to the issuer it reduces the need for an issuer to encourage registration through its registrar and therefore eliminates the costs associated with maintaining its own register.

The invention is attractive to financial services organizations such as brokerages as it allows them to offer value added services to their clients. Firstly they are able to provide their clients with information relating to shareholder privileges offered by Issuers and to do so at no marginal cost. This is information that may affect an investor's decision to buy or hold a particular stock and is therefore information that the brokerage will want to provide its clients. The invention also allows them to provide their clients with direct access to the transactions that earn shareholders their rewards. Additionally, it seems intuitive that by encouraging and promoting shareholder incentives the invention will generate a greater demand for share purchase transactions, a service provided by the brokerage.

Additionally, the invention is attractive to brokerages as it may allow them to learn of an issuer's registered shareholders, i.e. one of brokerages target markets. By definition a registered shareholder does not hold his or her shares in a brokerage account. We have seen that as the invention provides the issuer street name shareholder transparency and that the Issuer would benefit from not having to manage a register, so it follows Issuer would be prepared to share its registered shareholder information under the mechanics of the invention. Therefore, the brokerage is provided with a target audience of investors who hold stock but have no one managing their assets—a highly attractive source of new account and asset acquisition opportunities for the brokerage, the fundamental driver of a brokerages business.

The invention is attractive to Payment Systems and, where applicable, their Card Issuers, as the invention encourages the holding and use of such payment cards. The invention enables the Cardholders of a partnering payment system to automatically receive the shareholder rewards for which they are eligible, whether or not they were previously aware of the incentive program. Furthermore, through shareholder discounts offered by resellers of many Products and the fact that the invention can recognize an individuals indirect shareholding held through a mutual fund (associated with a 401k for example), the shareholder rewards are practicably available to a great number of people on a great number of Products. These rewards will not otherwise be readily accessible and thereby a user of a partnering Payment System/Card will materially benefit at no incremental cost to the Card Issuer.

The invention is attractive to shareholders as it provides them with a user-friendly system for learning of and receiving the rewards that they are eligible for in return for holding relevant stock. By encouraging an active interest in an individuals investments, whether this means an understanding of the company in which the hold shares or an understanding of the organizations in which their mutual fund holds stock, the shareholder is also better informed for when make decisions relating to their investments.

The invention involves the collating of all information relating to the shareholder incentives offered by all issuers. This data is obtained directly from each Issuer and is held in a central data repository managed by the invention's Database Administrator (“DBA”). This information is then made broadly available (and automatically in the case of Card transactions) to shareholders and prospective new shareholders by the invention, and therefore promotes the schemes of each Issuer at no incremental cost to the Issuer. The information is continuously updated to ensure it remains current and to give the Issuers the flexibility to change the terms of their incentives according to changing circumstances. At the same time the Issuer provides the DBA with access to information relating to their shareholder register. As will be shown, the DBA will use this information to validate the eligibility of registered shareholders to investor rewards on behalf of the Issuer.

The aforementioned shareholder reward information held by the DBA is made conveniently available to shareholders and prospective shareholders through such businesses as brokerages, information providers (e.g. MSN Money and Yahoo! Finance), Payments Systems/Card Issuers and a proprietary web site.

By definition the shareholder reward information is intended to affect whether an investor will choose to hold or purchase an Issuer's stock. Therefore, as it affects investment decisions, it is appropriate to have the information readily available through an investor's broker service providers. Accordingly, organizations such as brokerages have an interest in providing their clients with this information and the invention ensures they can.

However while this is true, there are two problems overcome by the invention that would otherwise prevent a brokerage from making shareholder reward information readily available. Firstly, the brokerage faces an administrative effort and associated cost in collecting the information from each Issuer and in ensuring that the information collected remains current. Advantageously, the present invention provides a real time central repository that can be effortlessly accessed by the brokerage eliminating any prohibitive administrative complications.

Secondly, shareholder rewards are typically offered to registered shareholders, as there is no current system that enables those that hold their shares in street name to redeem their shareholder rewards. Therefore a broker would be providing information that cannot benefit its clients unless they took the undesirable step of removing their shares from the brokers control and registering them directly. As will be shown however, the invention advantageously provides a process that allows the rewarding of street name shareholders without the direct registration of shares by the owner. Accordingly, through shareholder rewards, the invention enables the broker to provide a value added service that will materially benefit its clients without compromising its own interests. Furthermore, it will be demonstrated that there are other direct benefits to the broker in return for supporting shareholder rewards aside from improving its service offering to account holders.

Through the present invention the brokerage may choose to the present the information to its clients and prospective clients in a number of ways. For example, in the case of a brokerage providing online services, the simple task of inputting a market ticker to find company specific information will source shareholder incentive information—in the same way that it will provide share price, charts, research, analysts recommendations etc. This information may also be available through the web page presentation of a client's portfolio. Where an Issuer is listed in a client's portfolio there will be a link to further information about the company and this will include information regarding the shareholder incentives offered. There will also be a facility for a client to link to a shareholder incentive section that enables the researching of shareholder incentives generally. Alternatively, the client may request that the brokerage provides electronic or traditional mail alerts bringing any shareholder benefits related to his shareholding to his attention.

In addition, the brokerages will provide their clients with the opportunity to indicate their interest in receiving the shareholder benefits. This may be simply a “Yes” box to check that answers the question “Do you wish to receive shareholder rewards from the companies in which you hold stock?” Subsequently, the brokerage notifies the DBA of those investors wishing to receive shareholder rewards and, with consent; the brokerage provides information relating to their interest in specific Issuers. This is preferable as a condition of receiving shareholder rewards as a brokerage client, will be that your eligibility to receive these rewards can be validated. Validation may also be achieved by simply providing proof of ownership through a monthly portfolio statement for example.

Advantageously this process provides an effortless manner in which a street name shareholder can materially benefit from a shareholder rewards program ensuring the widespread acceptance of the invention. A further advantage is that the process allows eligibility to be immediately calculated in the clearing process based upon a direct shareholding in an Issuer as well as an indirect shareholding. For example, an investor may have an interest in a mutual fund that has an ownership in a given Issuer, the process allows for this indirect shareholding to be calculated and, where qualifying, to give access to shareholder rewards. In the theory therefore, an individual with an interest in a mutual fund linked to the S&P 500 index could be eligible to rewards offered by any of the 500 companies within the index. Alternatively, the invention provides for proprietary mutual funds to be offered to investors where by all Issuers held in a series of diversified funds provide the stakeholders with a representative interest in each company to qualify for shareholder rewards.

The shareholder reward information held is also made available to shareholders and prospective new shareholders through information providers. Examples of such organizations would be MSN Money and Yahoo! Finance. Again, these organizations are committed to providing investors with information that will effect an investment decision and thereby have an interest in providing information regarding shareholder incentives if made readily available to them. As with the brokerages the information providers will be given a single source for all relevant, current shareholder rewards data by the invention.

Additionally the present invention makes the shareholder reward information broadly available by incorporating a proprietary “Shareholder Rewards” website—a website specifically tailored to the needs an Issuer's customers who are current or prospective shareholders. As well as incentive information, this site will provide the commerce functionality that will enable the shareholders to actually conduct the transactions that earn shareholders their rewards. In other words, the invention promotes and facilitates the resale of the Issuer's Products offering rewards. As with the brokerages, the website also allows street name shareholders to register their interest in receiving shareholder rewards.

Direct links to this proprietary “Shareholder Rewards” website will be provided to shopping portals, as well as the aforementioned brokerages and information providers. Therefore the clients of the partnering brokerages will also effectively have direct access to their shareholder rewards from, for example, their portfolio summary web page. What's more where a shareholder is a registered shareholder or holds an account with a partnering brokerage through whom a shareholding can be validated, the website can provide immediate access to shareholder rewards. To explain, where the shareholder reward is a 10% discount, rather than this being paid retrospectively on a qualifying purchase, the website will enable the shareholder to purchase the Products at the net discounted price. This is made possible by the fact that the DBA will have access to a database of all registered shareholders and all street name shareholders who have registered their interest in eligibility to shareholder reward programs through partnering brokerages.

Also according to the processes of the present invention a shareholder will automatically receive the rewards when using a Card to make a qualifying purchase. Importantly the process will not only recognize the Cardholders eligibility to shareholder rewards offered by the Merchant but also the shareholder rewards offered by the manufacturers of the Products purchased. Advantageously, a Cardholder is able to receive shareholder rewards without having to know whether or not the rewards are offered. This means that a Cardholder will automatically have credited to their account the rewards even if they, or feasibly the Merchant from whom the Products are purchased, are not aware that the purchase qualifies for a reward.

In a preferred embodiment the process may be integrated with existing Payment Systems such as Visa and MasterCard. In such a case, it is facilitated by the manipulation of the inventions database by the DBA and its interaction with the payment system. To expand, the Payment System will request from the DBA confirmation of an Issuer offering a reward scheme, confirmation of the Cardholders eligibility and thereby authorization to credit the Cardholders account.

These and other features of the invention will be more fully understood by reference to the following drawings.

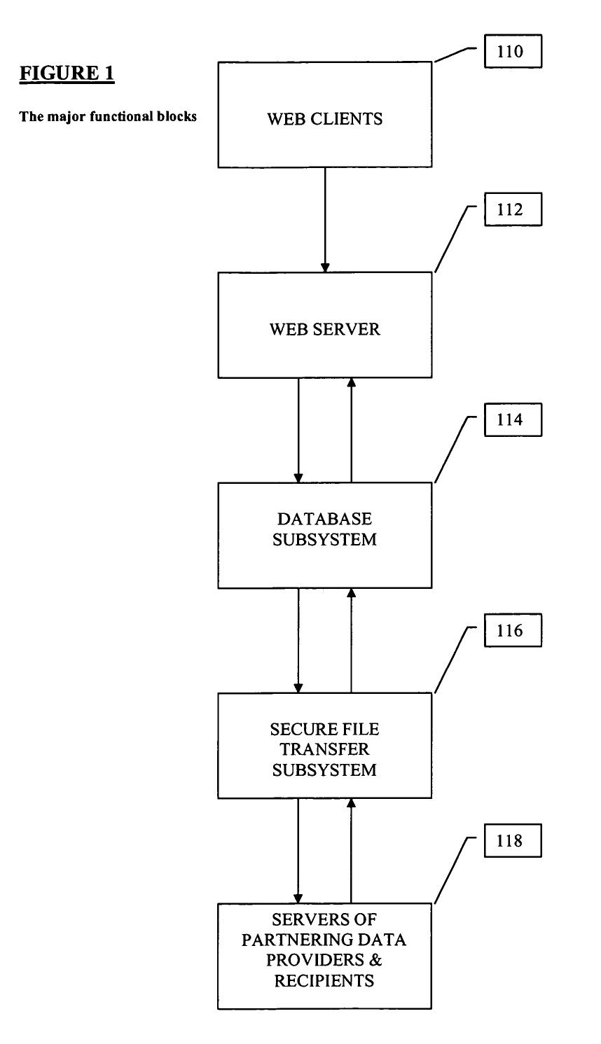

Referring to FIG. 1, which illustrates the main functional blocks of a preferred embodiment of the invention, a Database Subsystem 114 interacts with servers of partnering data providers and recipients 118 via a secure file transfer subsystem to facilitate the bi-directional passing of data relating to shareholder reward programs and shareholders. A Database Administrator manages the Database Subsystem 114. The partnering data providers and recipients 118 include Issuers, brokerages, information providers and Payment Systems for example. The information held in the Database Subsystem sourced from the servers of partners 118 is additionally made available to Web clients 110 using the World Wide Web to access the web server 112 of the invention. The web server 112 contains the web site of the present invention and is fed information by the database server and in turn provides web client provided information for storage in the database subsystem 114. An example web client 110 would be a shareholder holding a brokerage account with a partnering brokerage.

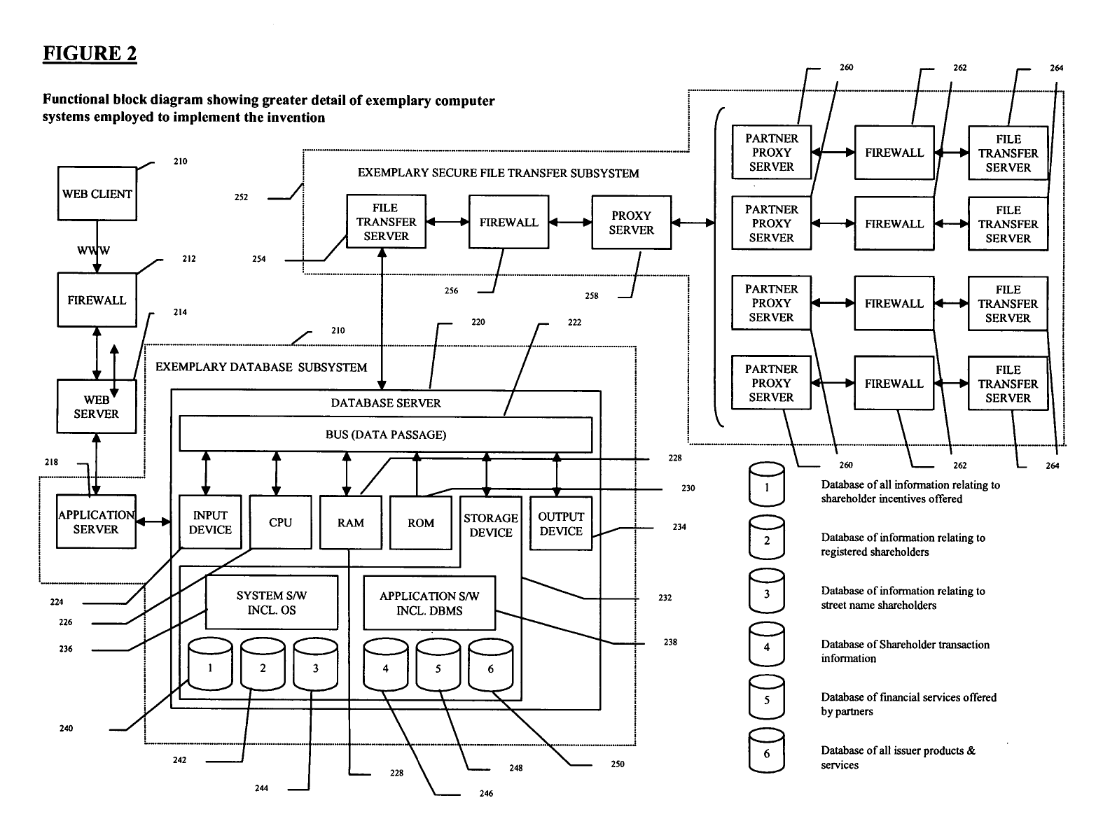

Referring to FIG. 2 greater detail of the main functional blocks of a preferred embodiment is provided. A preferred embodiment of a Database Subsystem 216 includes an application server 218 and a database server managed by a DBA 220. The database server 220 is demonstrated with the components of a common computer system; a BUS data passage 222, input devices such as keyboard/mouse 224, a Central Processing Unit (CPU) 226, Rapid Access Memory (RAM) 228, Read Only Memory (ROM) 230, Output devices such as printers/monitors 234 and storage device(s) 232. Storage device 232 will hold system software 236 such as the computer's operating system and application software such as the Database Management Software (DBMS) where such applications are not within the supporting application server 218. Also in the storage device 232 are data bases 240, 242, 244, 246, 248, 250. These databases hold information relating to the shareholder incentives offered by each issuer, registered shareholders, street name shareholders, shareholder transactions, financial services of partners, an issuers Products offered for sale amongst further information such as social security, Card information and contact details. These databases 240, 242, 244, 246, 248, 250 are populated through secure file transferring between partner organizations through exemplary secure file transfer subsystem 252. As previously stated, the partner organizations include brokerages, information providers and payment systems. Additionally the database server managed by DBA allows information to pass from databases 240, 242, 244, 246, 248, 250 to partner organizations through exemplary file transfer subsystem 252. As will be shown such information will include information provided to partners to promote the shareholder reward programs through partners such as brokerages and information providers and it will also include the information required to enable the payment system to confirm and authorize a Cardholders shareholding and thereby eligibility to rewards from purchases made using the Card. The exemplary secure file transfer subsystem will preferably include a File Transfer Server 252 of the Company that will prepare the files of the database subsystem 216 for transfer using a secure file transfer protocol such as S-HTTP. Unauthorized access to the private network of the invention will be provided by Firewall 256, in effect only allowing the requests filtered by the proxy server 258 to be fulfilled. The proxy server 258 will communicate with the proxy servers of partner organizations 260 passing information relating to fulfilled and unfulfilled data requests. Likewise the proxy servers 260 will filter authorized requests made by the Company to ensure only authorized data transfer takes place. These proxy servers 260 will have access to the partner's file transfer servers 264 through their own firewall 262. An extension to this diagram would see file transfers 264 communicate with the database subsystems of the partnering organizations that will enable information provided by the invention to be used in the course of conducting their own activities. For example, in the case of a partnering brokerage, through the secure file transfer subsystem 252 the brokerage will receive all information relevant to shareholder rewards so that it can in turn provide this information to its own customers. This may involve a further database subsystem, application server, web server, and firewall to make the information available to its web clients for example.

Additionally the exemplary database subsystem communicates with the web server that holds the Company's web site—this may be referred to as the “Shareholder Rewards” web site for example. Firewall 212 will protect this server from unauthorized access and serves web clients 210 through a communications network such as the Internet.

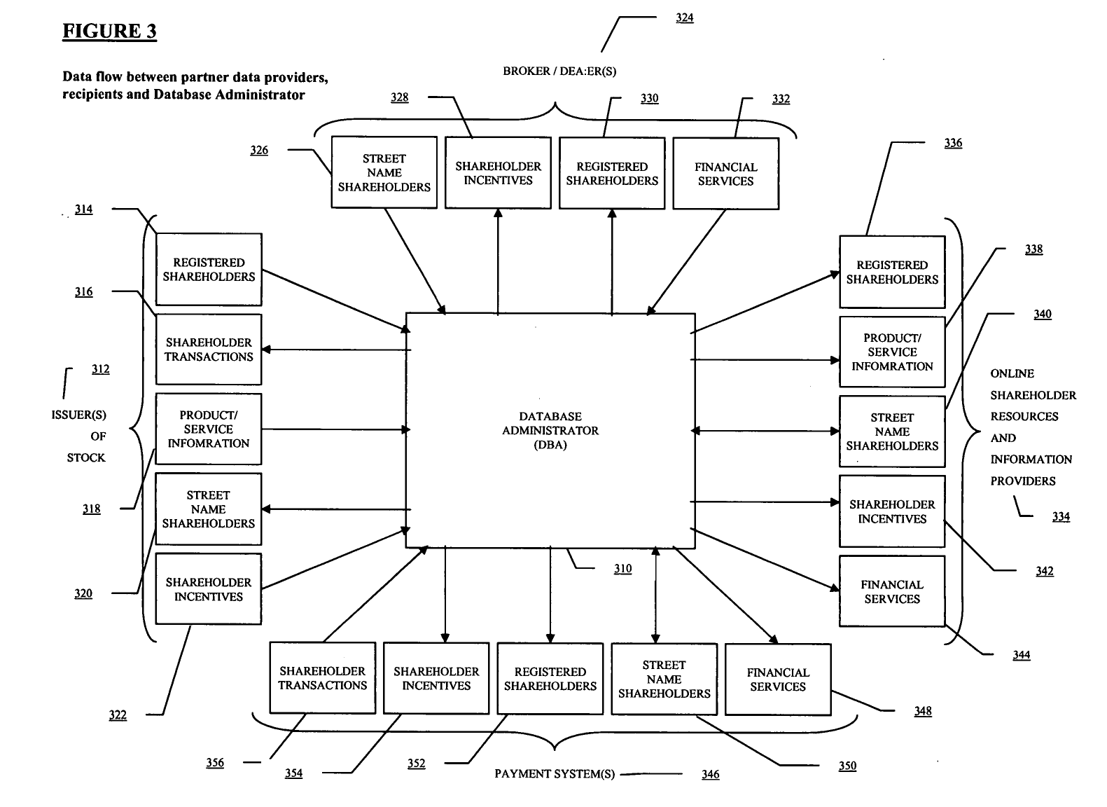

Referring to FIG. 3 more detail is provided regarding the data transfer described by the exemplary database subsystem and exemplary secure file transfer subsystems of FIG. 2. In a preferable embodiment the Database Administrator (DBA) 310 will interact with four categories of partners, the Issuers 312, financial services organizations such as brokerages 324, information providers and online shareholder resources 334 (which will include the Company's proprietary Shareholder Rewards website) and Payments systems 346. The Issuer 312 will provide the DBA 310 with information relevant to the Issuer's shareholder reward program 322 which will preferably include details on what incentives are offered on what product and any rules associated with shareholder eligibility. For example such rules may be in the form of a certain discount is available to those who have a certain number of shares or have held their shares for a given period of time. The Issuer 312 will also provide the DBA 310 with information regarding the Products its sells 318 and registered shareholders 314. Registered shareholder information 314 will include all individual shareholders registered, their holdings and all financial organizations holding assets on behalf of clients. Subsequently the DBA will make information available to brokerage partners 324 concerning all shareholder incentives 328 known to the DBA 310. This will allow the brokerage 324 to pass on shareholder rewards information to its clients. In return the brokerage 324 will provide information relating to their clients, i.e. street name shareholders 326 where these clients have registered their interest in receiving the shareholder rewards for which they are eligible. Where plausible the DBA 310 may also provide the brokerage 324 with information regarding an Issuer's registered shareholders such that the brokerage may solicit account and asset management business from these shareholders. Such freedom would to share this information would be dependent on the brokerage 324 providing the DBA 310 and thereby the Issuer 312 with information relating to the identity of the street name shareholders 320 of the Issuer. The brokerage 324 will also provide information 332 regarding the services it offers and in turn the DBA 310 will promote these services by distributing the information 344 and 350 to information providers 334 and partnering payment systems providers 348 respectively.

The DBA 310 will also distribute to the online shareholder resources and information providers 334 information regarding all Issuers shareholder incentives 342 and Products/Services for sale. In receiving this information the information providers and online shareholder resources are able to promote and facilitate the transactions that will earn a shareholder rewards. The DBA 310 will also selectively provide some of these partners with information relating to registered shareholders 336 and street name shareholders 340, such a party would be the proprietary shareholder reward web site. This information can then be used to automatically identity shareholders and confirm their eligibility to shareholder rewards. Such organizations may include a registration process such that street name shareholders can register their interest in receiving rewards and thereby will provide this information 340 to the DBA 310. In turn the DBA will provide the Issuer 312 with the information regarding its street name shareholders 320, such information to include shareholding information, contact details etc.

Additionally, the DBA 310 shares further information with the Payments Systems 348. The Payment System 346 will be provided with information that enables it to determine whether one of its Cardholders is a shareholder, whether the Card transactions made by the Cardholder concern Issuer's offering shareholder rewards and finally whether the Cardholder is eligible for any rewards offered. Accordingly, the DBA 310 provides the payment system 346 with Shareholder incentive information 354, registered shareholder information 352 and street name shareholders 348. By having this information they are also provided with the opportunity to inform their Cardholders what rewards could be earned if they were to become shareholders whilst also providing information on the brokerages financial services 348 such that their clients have easy access to purchasing shares if they wish to. Of course in return for information regarding whether a Cardholder is eligible for rewards, the payment system will provide information regarding the shareholder transactions made by its Cardholders 356. The DBA 310 makes this information available 314 to the Issuer such that they can understand the activities of their shareholders while also receiving confirmation of remittance due on shareholder rewards earned. The payment system 346 will also include the functionality that enables street name shareholders to register their interest in receiving the shareholder rewards and information regarding such individuals 350 will be passed to the DBA 310 who in turn will pass the information on to the corresponding Issuer 320 for their records.

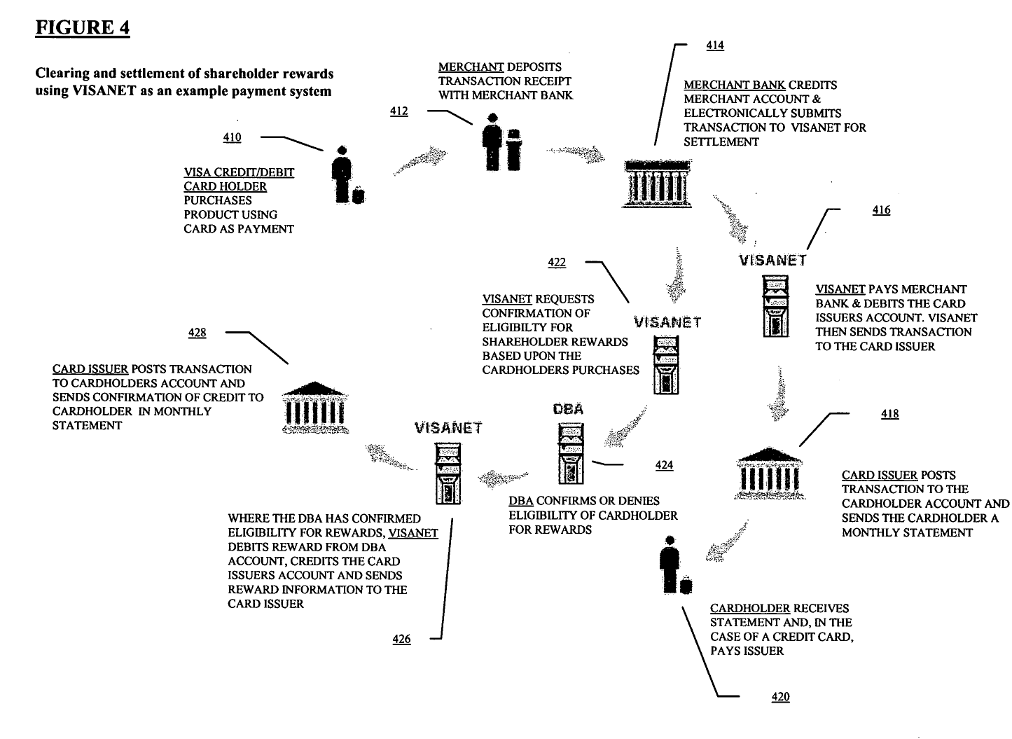

FIG. 4 illustrates the clearing and settlement of shareholder rewards using the VISANET payment system as an example embodiment. A Visa cardholder purchases a Product using the card as payment 410. The Merchant deposits the transaction receipt with its Merchant bank 412. The merchant bank will then credit the Merchants account for the transaction and electronically submits transaction to the VISANET payment system for settlement 414. Upon receipt of the transaction details, VISANET pays the Merchant Bank and debits the account of the actual Visa Card Issuer (Visa itself does not issue cards, rather this is performed by its member financial institutions) held with Visa. Visa then sends the transaction information to card issuer 416. Consequently, the Card Issuer posts the transaction to the Cardholder's account and sends the cardholder remittance advice or a monthly statement 418. Accordingly, the Cardholder receives the statement and in the case of a credit card pays the Issuer 420.

At the same time that VISANET processes the transaction 416, VISANET sends a request to the DBA for confirmation of the eligibility of the cardholder and the specific transaction for any shareholder rewards on offer 422. Upon receiving the request the DBA searches its database held information in order to confirm or deny eligibility of the Cardholder and the Cardholders transaction for rewards 424. Subsequently, where the DBA has confirmed qualification for rewards, VISANET debits the value of the rewards from the DBA account held with VISANET, credits the corresponding Card Issuers account and sends reward information to the card issuer. Where eligibility is denied VISANET end the enquiry or if desired, provide the Card Issuer with information regarding what rewards the Cardholder could have earned if they had been eligible 426. The Card Issuer posts the transaction to the Cardholders account and sends confirmation of a credit to the cardholder in a monthly or online statement for example 428. They may also post information regarding what rewards could have been earned in order to encourage the Cardholder to take advantage of the benefits being provided by the invention's payment system.

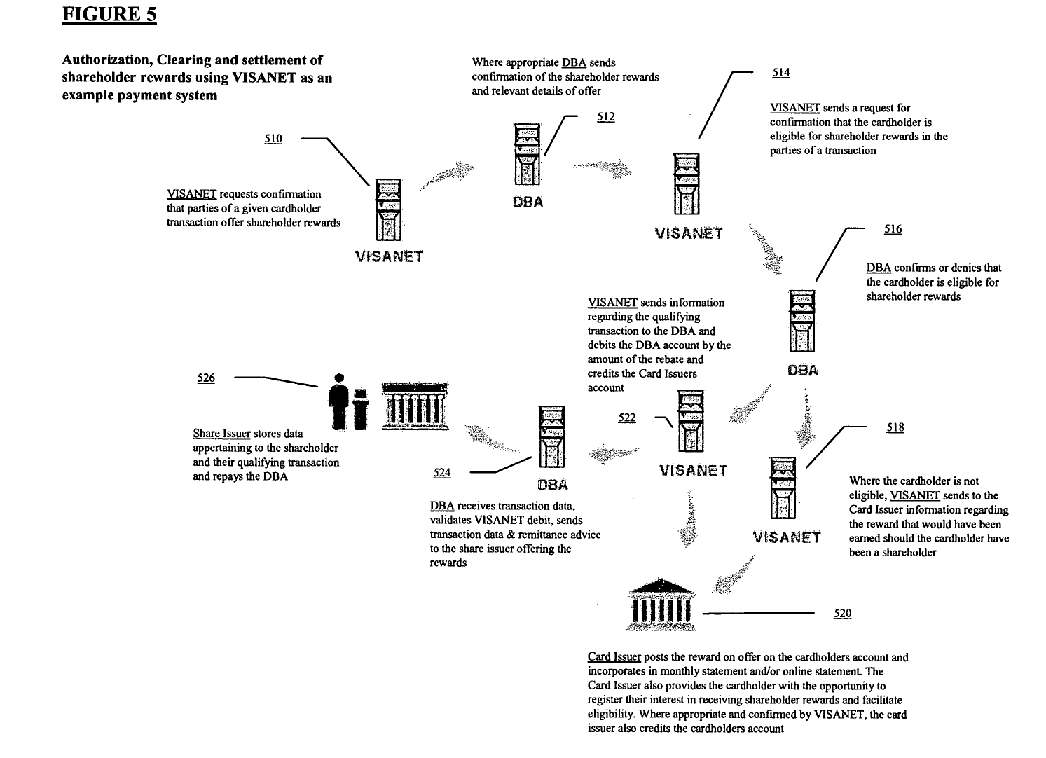

In referring to FIG. 5, authorization, clearing and settlement of shareholder rewards is illustrated, again using VISANET as an exemplary payment system incorporating the invention. In the process of handling a Cardholder purchase transaction, VISANET requests confirmation that parties of a given Cardholder transaction offer shareholder rewards 510. By parties, the invention means either the Merchant from whom the Products are purchased or the actual manufacturer of service provider of the Products. The DBA uses the Company database of shareholder incentives offered by Issuers to determine whether the parties of the transaction do offer shareholder incentives. Where the DBA confirms rewards are offered it sends all pertinent information regarding the rewards to VISANET 512. This information will include rules governing eligibility and the size of the rewards. Upon receiving confirmation of rewards offered, VISANET then sent a request to the DBA for confirmation that the Cardholder is eligible to receive the shareholder rewards 514 of the Issuers party to the transaction. This entails the Cardholder either being recognized as a registered shareholder of the Issuers or as a street name shareholder who has registered their interest in receiving shareholder rewards either through their broker, other information providers and shareholder resources or through the payment system itself.

The DBA confirms or denies that the Cardholder is eligible for shareholder rewards by searching the registered shareholder and street name shareholder database 516. In order for eligibility to be calculated in the case of street name shareholders if the information regarding the shareholders current ownership is not immediately available to the DBA, they will request confirmation of their shareholding in the Issuer from the managing brokerage. Eligibility can be granted on the back of a direct share ownership or indirect. For example, an individual with an interest in a mutual fund that holds shares in an Issuer will still in effect, own shares in the issuer and therefore may qualify for rewards. Accordingly the DBA forwards its response to VISANET. Where the Cardholder is not eligible, VISANET sends information regarding the rewards that could have been earned by the Cardholder should they have owned a qualifying interest in the issuer and takes no further action 518. Where the Cardholder is found to be eligible for rewards VISANET sends information regarding the qualifying transaction to the DBA. This information will include details of the Products purchased, the value of the transaction and the Merchant from whom the Products were bought. VISANET will at this time also deduct from the DBA account the funds equal to the amount of the rebate and consequently credits the appropriate Card Issuers account 522.

The Card Issuer then posts the rewards on offer to the Cardholders account whether or not they have been earned by the Cardholder through a monthly or online statement. In the case of VISANET providing confirmation of the Cardholders eligibility to the rewards on offer, the Card Issuer also credits the Cardholders account 520.

The DBA receives the transaction data for a qualifying shareholder purchase 524, validates the VISANET debit and sends the transaction data to the Issuer. At the same time the DBA prepares and sends remittance advice to the Issuer to cover the funds debited from the DBA account by VISANET. The Issuer stores data appertaining to the shareholder transactions and provides the DBA with the required compensation 526.

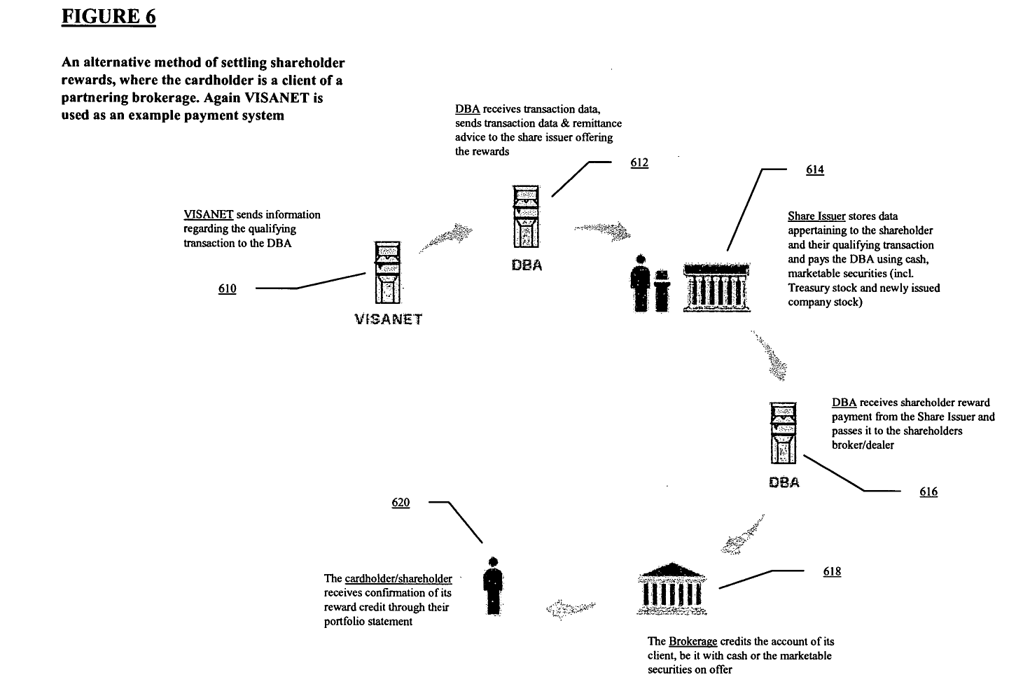

FIG. 6 provides an illustration of an alternative method of settling shareholder rewards, specifically where the Cardholder is a client of a partnering brokerage. Once more, VISANET is used as an exemplary payment system. In this embodiment, VISANET sends information regarding a qualifying Cardholder transaction to the DBA 610. Upon receiving the transaction data, forwards the transaction data and remittance advice to the corresponding Issuer(s) offering rewards according to the transaction 612. The Issuer stores the transaction data and pays the DBA using cash or marketable securities 614. In doing so the invention provides the Issuer with certain flexibility in how they finance their incentives. For example, the marketable securities may be in the form of newly issued shares. Accordingly, the issuer is able to finance incentives without impacting its cash flow. Furthermore, the DBA passes the shareholder reward payment directly to the shareholders brokerage account where the account is held with a partnering brokerage 616. This means that there is no such obligation on VISANET to clear the transaction. It also means that the DBA can present the shareholder with the option to receive the reward in form that the DBA receives payment from the Issuer. In other words, to continue the example of the Issuer financing rewards using newly issued stock, this can be passed on directly to the shareholder. In effect this makes the shareholder reward comparable to a dividend reinvestment scheme where by dividends are out towards increasing the interest of the shareholder. If the shareholder would rather cash, the DBA would liquidate any marketable securities received as payment to avoid any market exposure and the cost of which will be covered by the Issuer. Upon receiving the payment from the DBA, the brokerage credits the account of the shareholder with either cash or marketable securities 618 and the shareholder receives confirmation through their portfolio statement 620.

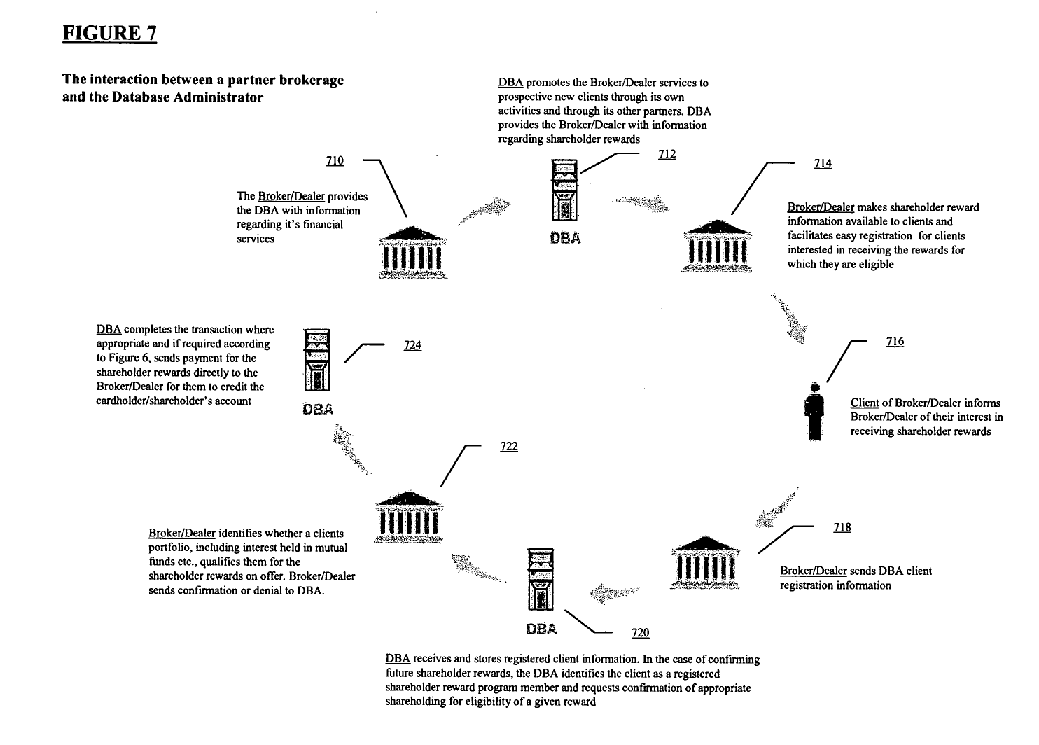

In referring to FIG. 7, which shows the interaction between a partner brokerage and the DBA, we begin with the broker dealer providing the DBA with information regarding the financial services it offers to clients. The purpose of this is so that the DBA can help promote the brokerages services to prospective new clients through its own activities and through its other partners. In return, the DBA provides the brokerage with the information regarding the shareholder reward programs offered by Issuers 712. The brokerage makes the shareholder reward information available to its clients and prospective clients through information mediums that serve their clients. An example of such a medium would be the brokerages web site. The information would be made available when a web site user searches for information on a particular company using a market ticker for example. Alternatively, the information on the Issuers of which a shareholder has an equity interest will be made available from the client's portfolio summary web page 716. In addition to providing this information the brokerage also provides its clients with an effortless method of registering their interest in automatically and freely receiving the shareholder rewards for which they are eligible. As described previously, this would preferably be achieved by a check box on the client's portfolio summary page. The clients thereby inform the brokerage of their interest in receiving shareholder rewards 716. In so doing they also commit to the disclosing of certain information relating to the fact they hold a brokerage account with a given brokerage and preferable provides permission for the DBA to validate their shareholding directly through their brokerage. Additionally as an extension of this, if the brokerage is able to provide the DBA and, therefore the Issuer, with information regarding its clients ownership in the issuer on a then current basis, the DBA will be able to offer in return the information that identifies the Issuer's registered shareholders who by definition own assets that are currently not being managed by a brokerage. The brokerage then sends the DBA client registration details 718. The DBA receives and stores the registered client information. In the case of a future requirement to validate the client's qualification for rewards, the DBA is now able to recognize the clients as generally eligible for shareholder rewards and can thereby request further information from the managing brokerage for validation of the client's shareholding 720. In the case where the information isn't already made available to the DBA, the brokerage will confirm the shareholders eligibility to rewards and sends corresponding approval or denial to the DBA 722. The DBA completes the transaction 724 according to the processes illustrated in FIGS. 5 and 6.

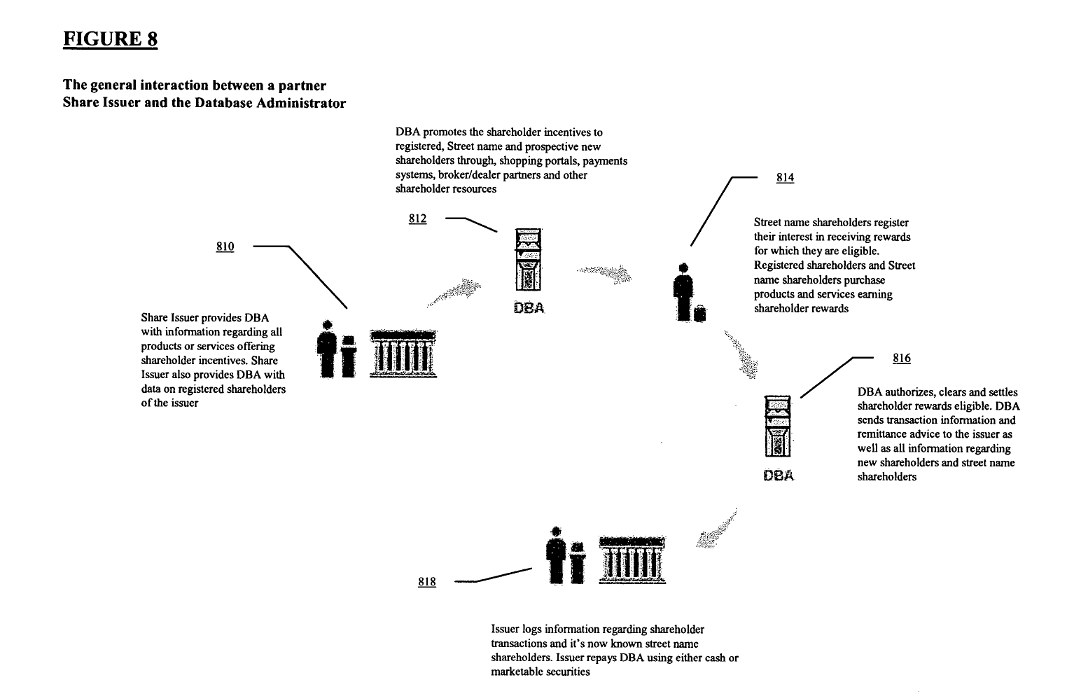

Referring to FIG. 8, the general interaction between a partner Issuer and the DBA is illustrated. The Issuer is shown to provide the DBA with information regarding all Products offering shareholders incentives. This includes the specific Products and the terms of the offer with respect to shareholder eligibility rules and the nature of the reward. The Issuer also provides general commerce information relating to their Products such that the DBA has all information required in order to promote the Products of the Issuer on the Issuers behalf 810. The DBA stores this information and makes it broadly available to the Issuer's shareholders and prospective new shareholders whether registered or street name through partnering shopping portals, information providers, shareholder resources, payment systems and brokerages 812. As we have seen earlier, the process of the invention leads to street name shareholders registering their interest in receiving shareholder rewards and thereby informs the DBA of their otherwise undisclosed ownership interest in the Issuers. Both registered and unregistered shareholders purchase Products earning shareholder rewards 814. The DBA authorizes, clears and settles shareholder rewards payable. The DBA also sends transaction information and remittance advice to the issuers as well as all information regarding new shareholders and street name shareholders 816. The Issuer logs information regarding the shareholder transactions and its now known street name shareholders. This information preferably includes contact details such as interaction between the Issuer and its shareholders can be continued. The issuer repays the DBA 818 using either cash or marketable securities in accordance with FIGS. 4, 5 and 6.

1. A system for providing shareholder related service by accessing a shareholder reward information database comprising:
a database comprising information about a plurality of issuers of stock wherein for each of said plurality of issuers, information is stored in at least three categories:
an issuer's name,
a roster of shareholders holding the issuer's shares, and
a list of rewards or incentives, if any, offered by the issuer for the benefit of the shareholders, and;
a database functionality that enables accessing the database with requests for desired information, and providing information in one or more of the categories in response to the requests;
wherein the service is provided by allowing a user access to the shareholder reward information and providing information to the user as a result of the access.
